(19) United States
(12) Patent Application Publication
(10) Pub. No.: US 2013/0208812 A1
(43) Pub. Date: Aug. 15, 2013

(54) HIGH-SPEED INTERFACE FOR ANCILLARY DATA FOR SERIAL DIGITAL INTERFACE APPLICATIONS

(71) Applicants: John Hudson, Burlington (CA); Tarun Setya, Pleasanton, CA (US); Nigel Seth-Smith, Lymington (GB)

(72) Inventors: John Hudson, Burlington (CA); Tarun Setya, Pleasanton, CA (US); Nigel Seth-Smith, Lymington (GB)

(21) Appl. No.: 13/806,373

(22) PCT Filed: Jun. 22, 2011
(86) PCT No.: PCT/CA11/50381

§ 371 Date: Apr. 26, 2013

Related U.S. Application Data
(60) Provisional application No. 61/357,246, filed on Jun. 22, 2010.

(51) Int. Cl. H04N 7/085

(52) U.S. Cl. CPC H04N 7/085
USPC 375/240.26

(57) ABSTRACT

A high speed interface for ancillary data is provided. The interface extracts ancillary data encoded in a serial digital data signal received over the serial digital data input; assembles a plurality of data packets, each packet comprising identification information identifying the data packet, length information identifying a length of the data packet, and value information representing a portion of the extracted ancillary data; sequentially encodes the plurality of data packets within a high-speed data stream; and transmits the high speed data stream via a high speed data output.

This application claims the benefit of and priority to U.S. Patent Application Ser. No. 61/357,246 filed Jun. 22, 2010, the contents of which are incorporated herein by reference.

### BACKGROUND

Example embodiments described in this document relate to a high-speed interface for ancillary data for serial digital interface applications.

Serial Digital Interface (“SDI”) refers to a family of video interfaces standardized by the Society of Motion Picture and Television Engineers (“SMPTE”). SDI is commonly used for the serial transmission of digital video data within a broadcast environment. Ancillary data (such as digital audio and control data) can be embedded in inactive (i.e. non-video) regions of a SDI stream, such as the horizontal blanking region for example.

High-speed interfaces can be used to extract ancillary data from a SDI stream for processing or transmission or to supply ancillary data for embedding into an SDI stream, or both.

### TECHNICAL FIELD

This disclosure relates to the field of high speed data interfaces.

### BRIEF DESCRIPTION OF THE DRAWINGS

FIG. 1 is a representation of an example of an SDI digital video data frame;

FIG. 2 is block diagram of a production video router illustrating a possible application of a HSI transmitter and an HSI receiver according to example embodiments;

FIG. 3 is block diagram of a master control illustrating another possible application of a HSI transmitter and an HSI receiver according to example embodiments;

FIG. 4 is block diagram of an audio embedder/de-embedder illustrating a further possible application of a HSI transmitter and an HSI receiver according to example embodiments;

FIG. 5 is block diagram of an audio/video monitoring system illustrating still a further possible application of a HSI transmitter and an HSI receiver according to example embodiments;

FIG. 6 is a block diagram of an SDI receiver having an integrated HSI transmitter according to an example embodiment;

FIG. 7 is an illustration of an SDI input into the SDI receiver of FIG. 6 and an HSI output from the HSI transmitter of FIG. 6, showing audio data extraction from the SDI data stream;

FIG. 8 is a block diagram of an SDI transmitter having an integrated HSI receiver according to an example embodiment;

FIG. 9 is an illustration of an HSI input to the HSI receiver of FIG. 8 and an SDI output from the SDI transmitter of receiver of FIG. 8, showing audio data insertion into an SDI stream;

FIG. 10 is a block diagram representation of an SD-SDI ancillary data packet;

FIG. 11 is a block diagram representing Key Length Value (“KLV”) packet formatting of an HD-SDI ancillary data packet;

FIG. 12 is a block diagram representing an Embedded Audio Sample Reference Clock in the output of the HSI transmitter according to an example embodiment;

FIG. 13 is a block diagram representing burst preambles for Dolby E data;

FIG. 14A is a block diagram illustration of 4b/5b Encoding according to an example embodiment;

FIG. 14B is a block diagram illustration of 4b/5b Decoding according to an example embodiment;

FIG. 15 is a block diagram illustration of transmission of audio groups with horizontal blanking;

FIG. 16 is a block diagram representing KLV Packet Formatting of Audio Data (SD data rates) according to another example;

FIG. 17 is a block diagram representing KLV packet formatting of a HD audio control packet;

FIG. 18 is a block diagram representing KLV packet formatting of a SD audio control packet;

FIG. 19 is a block diagram representing KLV packet formatting of a two-frame marker (“TFM”) packet; and

FIG. 20 is a block diagram representing an Embedded Audio Sample Reference Clock in the output of the HSI transmitter according to an alternative embodiment to the embodiment shown in FIG. 12.

### DESCRIPTION OF EXAMPLE EMBODIMENTS

Examples embodiments of the invention relate to a high-speed serial data interface (“HSI”) transmitter that can be used to extract ancillary data (such as digital audio and control data) from the inactive regions (i.e. non-video) of a Serial Digital Interface (“SDI”) data stream for further processing and an HSI receiver for supplying ancillary data to be embedded into the inactive regions of an SDI data stream.

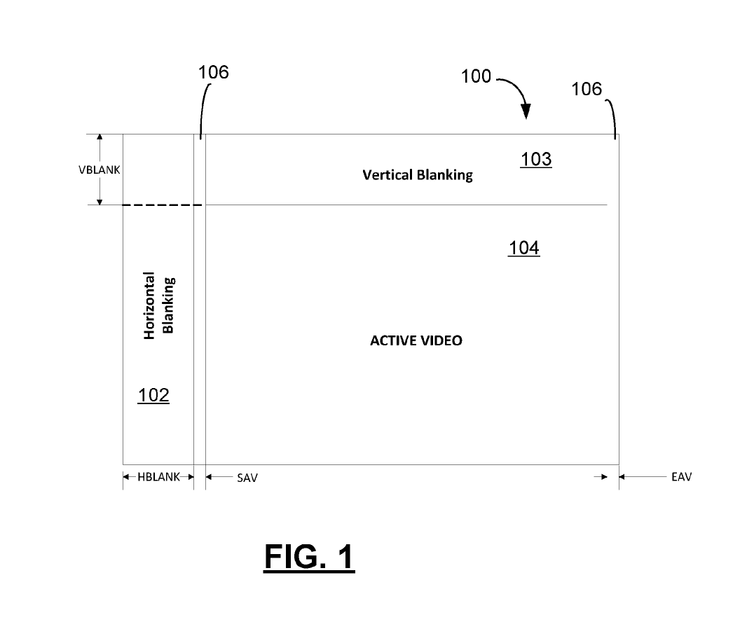

As previously noted, SDI is commonly used for the serial transmission of digital video data within a broadcast environment. As illustrated shown in FIG. 1, within the raster structure of a video frame 100, inactive (blanking) regions including horizontal blanking region 102 and vertical blanking region 103 surround the active image 104 and contain ancillary data such as digital audio and associated control packets. Synchronization information 106 defines the start and end of each video line.

As SDI data rates increase, the bandwidth available for carrying ancillary data such as digital audio also increases. For example, 3G-SDI formats can accommodate 32 channels of audio data embedded within the horizontal blanking region 102. In some large router/switcher designs, routing the 16 channel pairs that make up the 32 channels of audio data to “audio breakaway” processing hardware can be impractical, especially as the density of SDI channels within these components continues to increase. Additionally, other broadcast components such as audio embedder/de-embedders and monitoring equipment may use Field-Programmable Gate Arrays (“FPGA”) for audio processing, and pins are at a significant premium on most FPGA designs.

Example embodiments described herein include an HSI transmitter and HSI receiver that in some applications can provide a convenient uni-directional single-wire point-to-point connection for transmitting audio data, notably for “audio breakaway” processing where the audio data in an SDI data stream is separated from the video data for processing and routing. In some applications, for example in router and switch designs, a single-wire point-to-point connection may ease routing congestion. In some applications, for example when providing audio data to an FPGA, a single-wire interface for transferring digital audio may reduce both routing complexity and pin count.

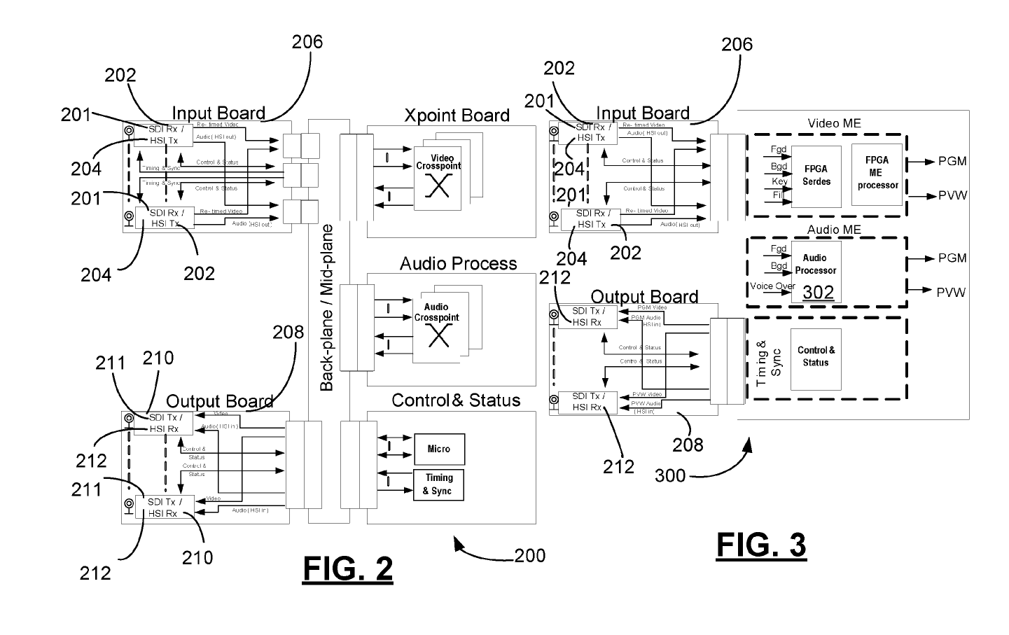

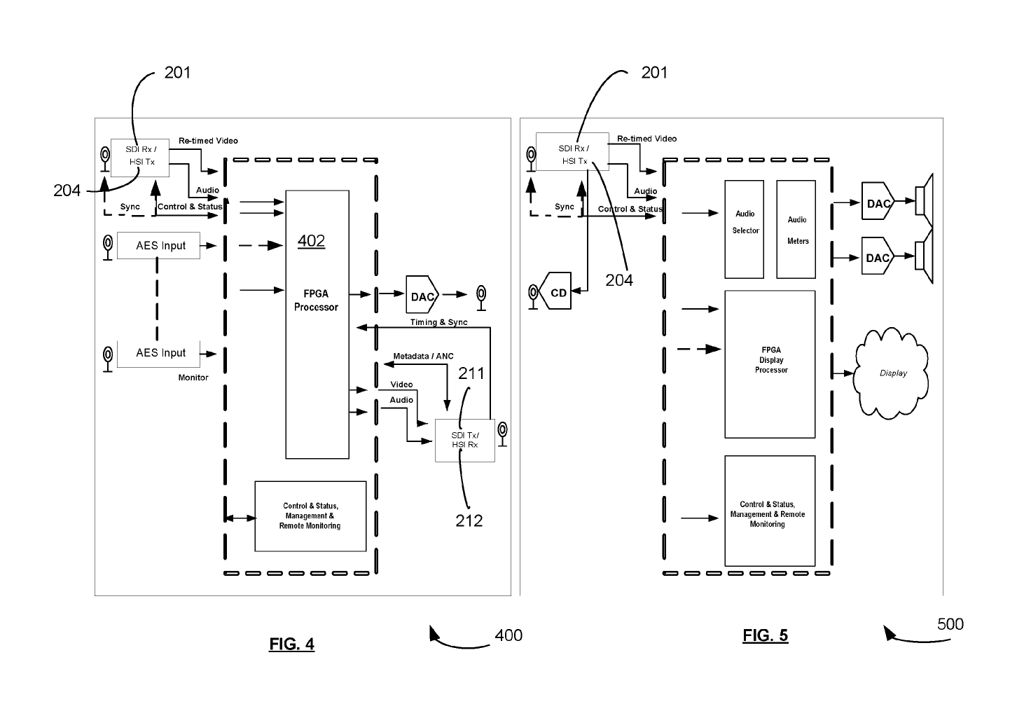

By way of example, FIG. 2 illustrates an example of a production video router 200 and FIG. 3 illustrates an example of a master control 300 for SDI processing that HSI devices such as those described herein may be incorporated into. For example, video router 200 and master control 300 can each include an input board 206 that has an integrated circuit 202 mounted thereon that includes an SDI receiver 201 with an embedded HSI transmitter 204, and an output board 208 that has an integrated circuit 210 mounted therein that includes an SDI transmitter 211 with an embedded HSI receiver 212. In some example embodiments, the circuitry for implementing integrated circuits 202 and 210 can be in a single integrated circuit chip.

In large production routers such as video router 200 and master controllers such as controller 300, if the received audio data is formatted as per AES3, each audio channel pair would require its own serial link, and the routing overhead for 16 channel pairs creates challenges for board designs. However, according to example embodiments described herein, each audio channel pair is multiplexed onto a high-speed serial link along with supplemental ancillary data such as audio control packets and audio sample clock information, such that all audio information from the video stream can be routed on one serial link output by HSI transmitter 204, and demultiplexed by the audio processing hardware (for example audio processor 302 of master controller 300).

In example embodiments, audio sample clock information embedded on the HSI data stream produced by HSI transmitter 204 can be extracted by the audio processing hardware (for example audio processor 302), to re-generate an audio sample reference clock if necessary. After audio processing, the audio processing hardware (for example audio processor 302) can re-multiplex the audio data and clock information onto the HSI data stream as per a predefined HSI protocol. The processed ancillary data (e.g. the audio payload data and clock information) in the HSI data stream can be embedded by HSI receiver 212 into a new SDI link at the output board 208.

Another example application of the HSI is illustrated in FIG. 4 which illustrates an SDI receiver 201 having an embedded HSI transmitter 204 and an SDI transmitter 211 having an embedded HSI receiver 212 within an audio embedder/de-embedder system 400. In one example, audio data is extracted from the SDI data stream and routed via the HSI transmitter 204 to an FPGA 402 for audio processing. The extracted audio data is then multiplexed onto the FPGA's output HSI port along with additional audio data provided on the AES input channels, and re-inserted into the horizontal blanking region of an SDI data stream by the SDI transmitter 211 that accepts the multiplexed audio data as an input to its HSI receiver 212. Since FPGA designs are often pin-limited the HSI can in some applications reduce routing overhead in that it consumes only one (differential) input of the FPGA 402, while allowing the transfer of multiple channels of audio data (for example 32 channels in the case of 3G-SDI).

A further example application of HSI is shown in FIG. 5 which depicts an audio/video monitoring system 500 that includes a SDI receiver 201 having an embedded HSI transmitter 204. One of 16 stereo audio pairs can be selected for monitoring using an audio multiplexer. Again, in some applications a reduction in routing overhead can be realized.

Accordingly, it will be appreciated that there a number of possible applications for an HSI that comprises a single-wire interface used for point-to-point transmission of ancillary data (such as digital audio and control data) for use in SDI systems.

In at least some examples the usage models of the HSI within the SDI application space include HSI transmitter 204 and HSI receiver 212. In some examples, the HSI transmitter 204 is used to extract ancillary data from standard definition (“SD”), high definition (“HD”) and 3G SDI sources, and transmit them serially. An HSI transmitter 204 may for example be embedded within an SDI Receiver 201 or an input reclocker. In some examples, the HSI receiver 212 is used to supply ancillary data to be embedded into the inactive (i.e. non-video) regions of a SDI stream. An HSI receiver 212 may for example be embedded within an SDI Transmitter 211 or an output reclocker.

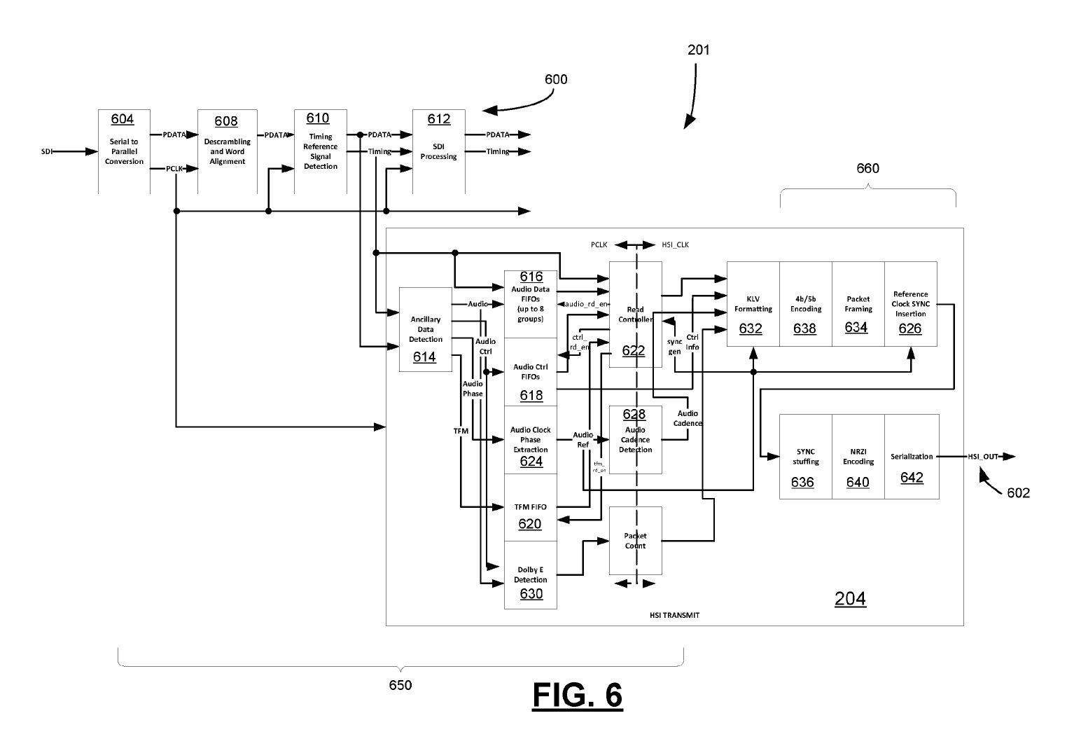

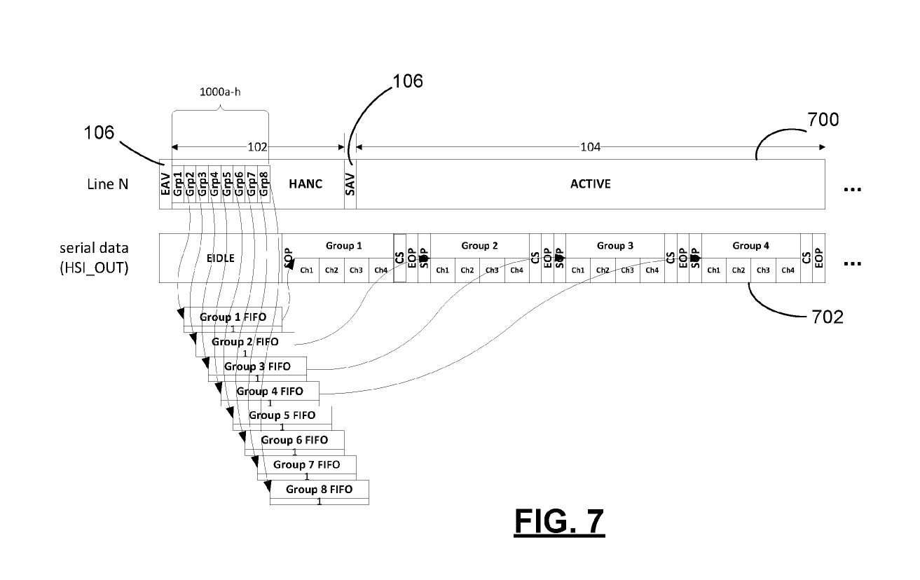

FIG. 6 illustrates SDI receiver 201 having an embedded HSI transmitter 204 in greater detail, according to an example embodiment. In addition to HSI transmitter 204, the SDI receiver 201 includes SDI receiver circuit 600. The HSI audio data and ancillary data extraction performed by the SDI receiver 201 and integrated HSI transmitter 204 is illustrated in FIG. 7 which includes a diagrammatic representation of Line N 700 of an SDI data stream received at the SDI input of SDI receiver 201 and the resulting serial data (HSI_OUT) 702 output from the HSI transmitter 204. In FIG. 7, SMPTE audio packets 1000a-h are identified by audio group. In the illustrated example, each audio group contains 4 audio channels, where Group 1 corresponds to channels 1-4, Group 2 corresponds to channels 5-8, and so on up to Group 8 (channels 29-32).

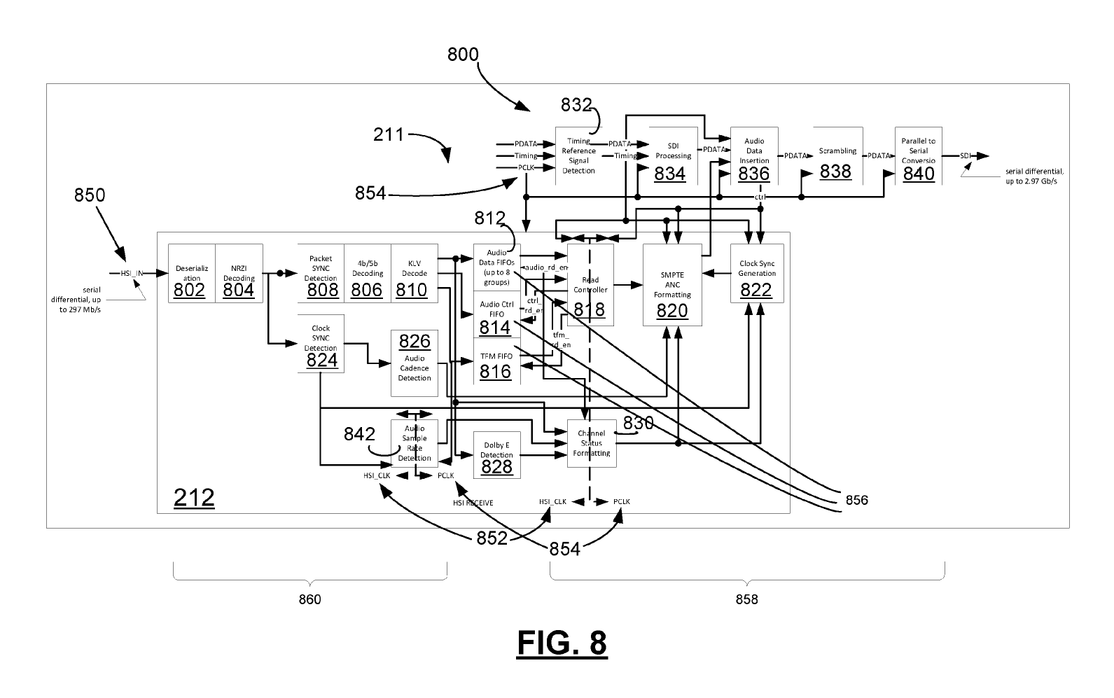

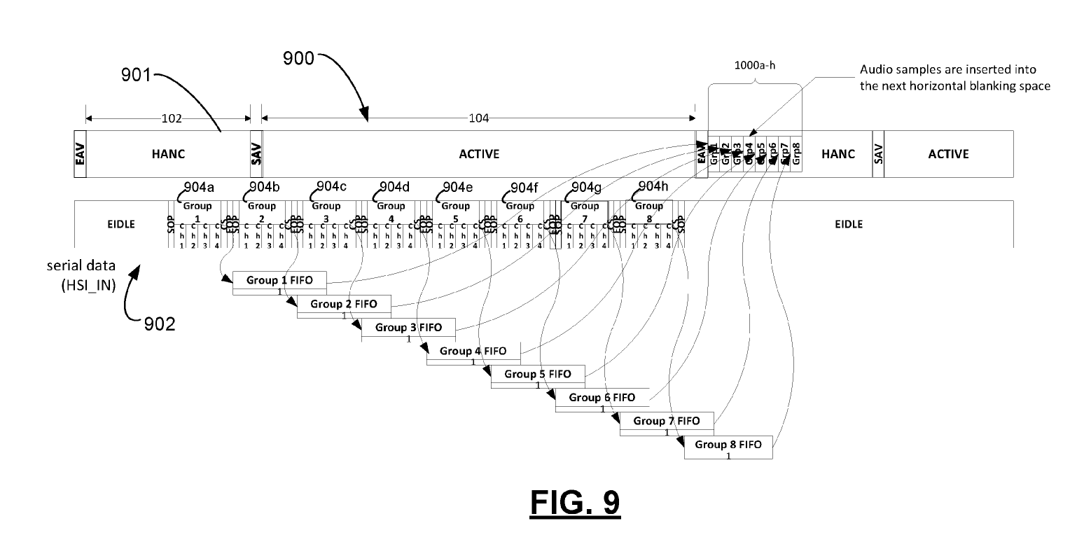

FIG. 8 illustrates SDI transmitter 211 having an embedded HSI receiver 212 in greater detail, according to an example embodiment. In addition to HSI receiver 212, the SDI transmitter 201 includes SDI transmitter circuit 800. The HSI audio data insertion performed by the SDI transmitter 211 and integrated HSI receiver 212 is illustrated in FIG. 9 which includes a diagrammatic representation of the serial data (HSI_IN) 902 received at the input of the HSI receiver 212 and the resulting Line N and N+1 901 of an SDI data stream 900 transmitted from the SDI output of SDI processing circuit 800.

In FIGS. 7 and 9, SMPTE audio packets 1000a-h are identified by audio group 904a-h. In the illustrated example, each audio group 904 contains 4 audio channels, where Group 1 904a corresponds to channels 1-4, Group 2 904b corresponds to channels 5-8, and so on up to Group 8 904h (channels 29-32).

An example embodiment of an HSI transmitter 204 as shown in FIG. 6 will now be explained in greater detail. In some examples, the HSI transmitter 204 is used to extract up to 32 channels of digital audio from SD, HD or 3G SDI sources, and transmit them serially on a uni-directional single-wire interface 602. In example embodiments, the HSI supports synchronous and asynchronous audio, extracted directly from ancillary data packets. The audio data may for example be PCM or non-PCM encoded.

As noted above, in addition to the embedded HSI transmitter 204, the SDI receiver of 201 of FIG. 6 also includes an SDI receiver circuit 600 for receiving an SDI data stream as input. In the SDI receiver circuit 600, the received SDI data is deserialized by a serial to parallel conversion module 604, the resulting parallel data descrambled and word aligned by a descrambling and word alignment module 608, and timing reference information embedded in the video lines extracted at timing and reference signal detection module 610. The extracted timing and reference signal data (Timing) is provided as an input to HSI transmitter 204 and used to control the ancillary data extraction process performed on the video line data (PDATA) that is also provided as an input to the HSI transmitter 204. The SDI receiver circuit 600 can also include an SDI processing module 612 for processing the video data downstream of the audio data extraction point.

In example embodiments, the HSI transmitter 204 operates at a user-selectable clock rate (HSI_CLK 852) to allow users to manage the overall latency of the audio processing path—a higher data rate results in a shorter latency for audio data extraction and insertion. At higher data rates, noise-immunity is improved by transmitting the data differentially. The user-selectable clock rate HSI_CLK 852 may be a multiple of the video clock rate PCLK to facilitate an easier FIFO architecture to transfer data from the video clock domain. However, the HSI transmitter 204 can alternatively also run at a multiple of the audio sample rate so that it can be easily divided-down to generate a frequency useful for audio processing/monitoring. Due to the way sample clock information is embedded in the HSI stream (as explained below), the HSI clock is entirely decoupled from the audio sample clock and the video clock rate, and any clock may be used for HSI_CLK 852.

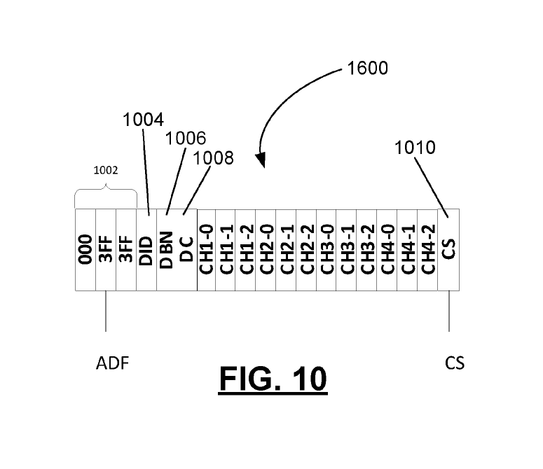

Within the HSI transmitter 204, the video line data PDATA and the extracted timing signal are received as inputs by ancillary data detection module or block 614 and ancillary data detection is accomplished by searching for ancillary data packet headers within the horizontal blanking region 102 of video line data PDATA. In an example embodiment, each ancillary data packet is formatted as per SMPTE ST 291. An example of an SMPTE ancillary data packet (specifically an SD-SDI packet 1600) is shown in FIG. 10, containing:
Ancillary Data Header (ADF) 1002: a unique word sequence that identifies the start of an ancillary data packet (000h, 3FFh, 3FFh)
Data ID Word (DID) 1004: a unique word that identifies the ancillary data packet type
Data Block Number or Secondary Data ID Word (DBN or SDID) 1006: the DBN is a word that indicates the packet number (in a rolling number sequence); otherwise the SDID identifies the ancillary data packet sub-type, if present.
Data Count (DC) 1008: indicates the number of words in the packet payload
Checksum (CS) 1010: a checksum of the payload contents for bit error detection

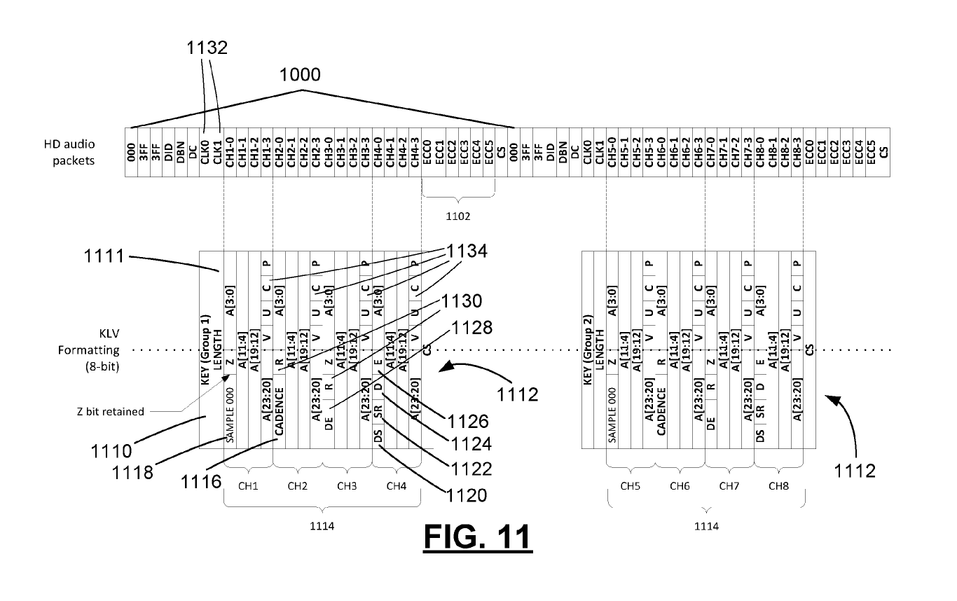

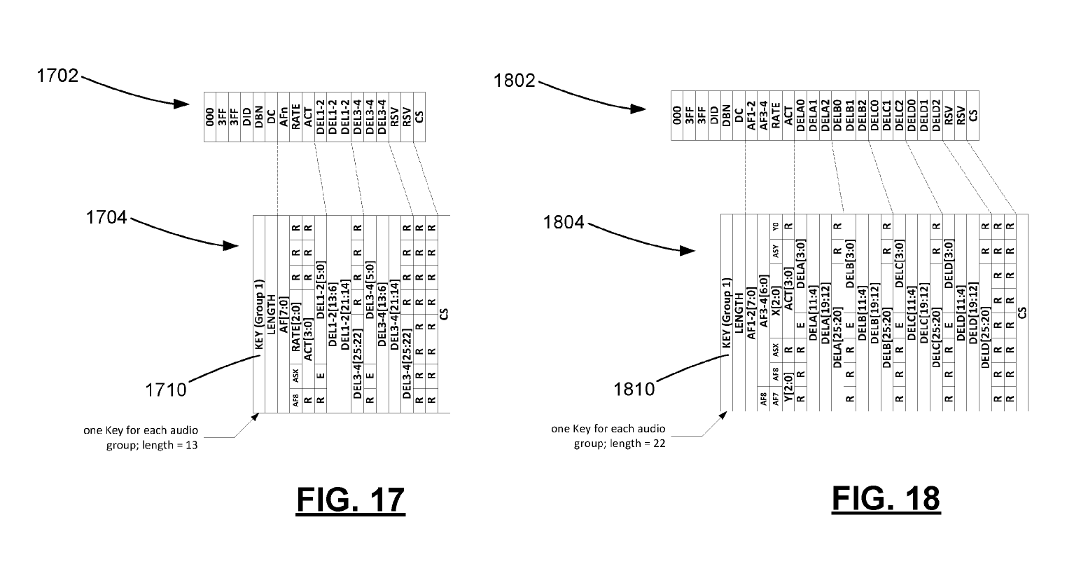

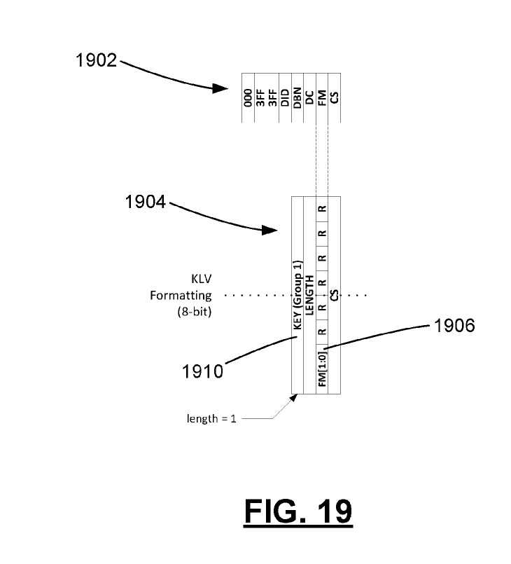

The ancillary data detection block 614 searches for DIDs corresponding to audio data packets (1600 or 1000—see FIGS. 10 and 11), audio control packets (1702 or 1802—see FIGS. 17 and 18), and Two-Frame Marker (TFM) packets (1902—see FIG. 19). SMPTE audio and control packet DIDs are distinguished by audio group. Each audio group contains 4 audio channels, where Group 1 corresponds to channels 1-4, Group 2 corresponds to channels 5-8, and so on up to Group 8 (channels 29-32).

Audio Data FIFO buffers 616 are provided for storing the audio data extracted at detection block 614. Audio data is extracted during the horizontal blanking period 102 and each audio data packet 1000, 1600 is sorted by audio group and stored in a corresponding audio group FIFO buffer 616 where the audio data packet 1000, 1600 is tagged with a sample number to track the order in which packets are received. In an example, for HD-SDI and 3G-SDI data rates, each audio data packet 1000 contains 6 ECC words (see FIG. 11, numeral 1102). In example embodiments, these ECC words 1102 are not stored in the FIFO buffers 616, as ECC data is not transmitted over the HSI.

After the first audio data packet 1000, 1600 on a line is received, the HSI transmitter 204 can begin transmitting serial audio data for that line.

Audio Control FIFO buffers 618 are provided for storing audio control packets 1702, 1802 (examples of a high definition audio control packet 1702 can be seen in FIG. 17 and a standard definition audio control packet 1802 can be seen in FIG. 18) extracted for each audio group by detection block 614. Audio control packets 1702, 1802 are transmitted once per field in an interlaced system and once per frame in a progressive system. Similar to audio data, audio control packets 1702, 1802 are transmitted serially as they are extracted from the data stream.

A TFM FIFO buffer 620 is used to store the Two-Frame Marker packet 1902 (an example of TFM Packet 1902 can be seen in FIG. 19). This packet is transmitted once per frame, and is used to provide 2-frame granularity for downstream video switches. This prevents video switching events from “cutting across” ancillary data that is encoded based on a two-frame period (non-PCM audio data is in this category). Similar to audio data, the TFM packets 1902 are transmitted serially as they are extracted from the data stream.

Collectively, the serial to parallel conversion module 604, word alignment module 608, timing and reference signal detection module 610, SDI processing module 612, ancillary Data Detection module 614, Audio Data FIFO buffers 616, Audio Control FIFO buffers 618, and TFM FIFO buffer 620 operate as serial data extraction modules 650 of the SDI receiver 201.

A FIFO Read Controller 622 manages the clock domain transition from the video pixel clock (PCLK) to the HSI clock (HSI clock requirements are discussed below). As soon as audio/control/TFM data is written into corresponding FIFO buffers 616, 618, 620, the data can be read out to be formatted and serialized. Ancillary data is serviced on a first-come first-serve basis.

Audio Clock Phase Extraction block 624 extracts audio clock phase information. In example embodiments, audio clock phase information is extracted in one of two ways:
For HD-SDI and 3G-SDI data, it is decoded from specific clock phase words in the SMPTE audio data packet 1000 (see FIG. 10)
For SD-SDI, it is generated internally by the HSI transmitter 204, synchronized to the video frame rate.

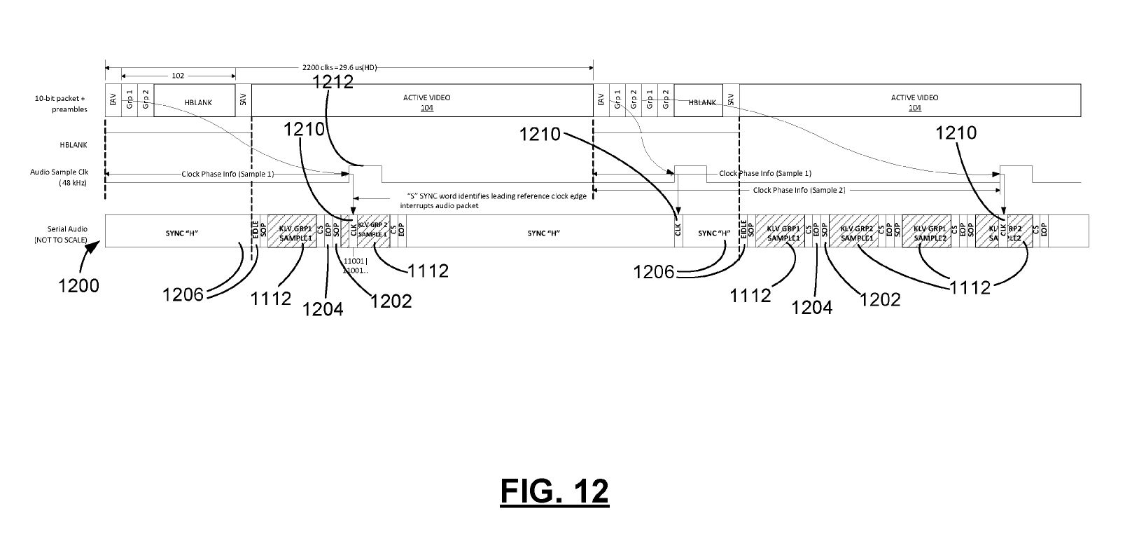

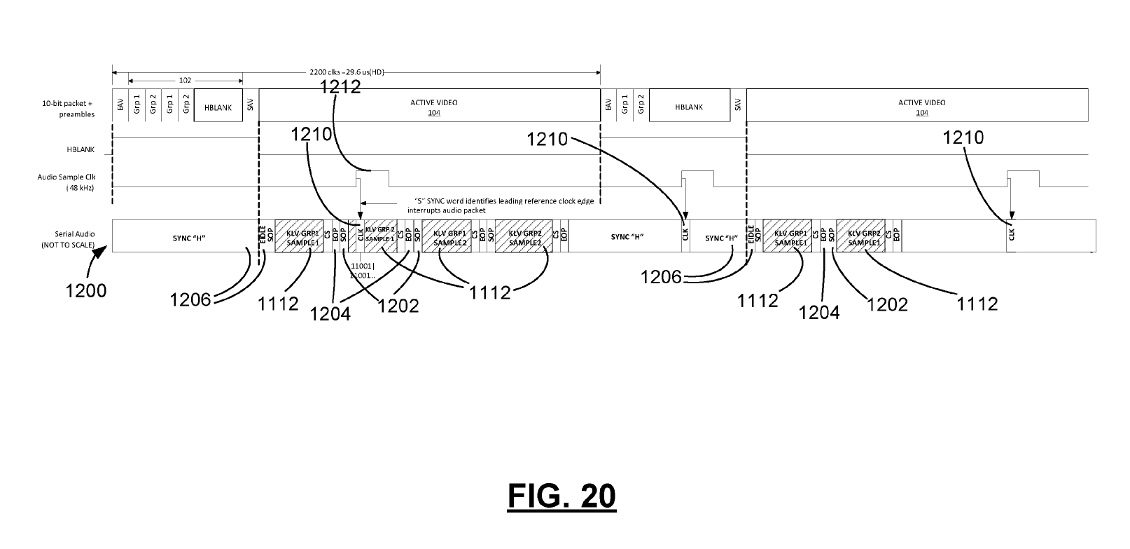

Reference clock information is inserted into the HSI data stream by reference clock SYNC insertion block 626. In one example, the reference clock is transmitted over the HSI via unique synchronization words 1210 (see FIGS. 12 and 20) that are embedded into the HSI stream on every leading edge of the audio reference clock, so the audio sample reference clock can be easily re-generated in downstream equipment. Data reads from the FIFO are halted on every leading edge of the audio sample reference clock 1212, so the clock sync word can be embedded. FIG. 12 and FIG. 20 illustrate an example of an embedded audio sample reference clock in the HSI_OUT data stream.

Audio Cadence Detection block 628 uses audio clock phase information from audio clock phase extraction block 624 to re-generate the audio sample reference clock 1210 and this reference clock is used to count the number of audio samples per frame to determine the audio frame cadence. For certain combinations of audio sample rates and video frame rates, the number of audio samples per frame can vary over a specified number of frames (for example, up to five frames) with a repeatable cadence. In some applications, it is important for downstream audio equipment to be aware of the audio frame cadence, so that the number of audio samples in a given frame is known.

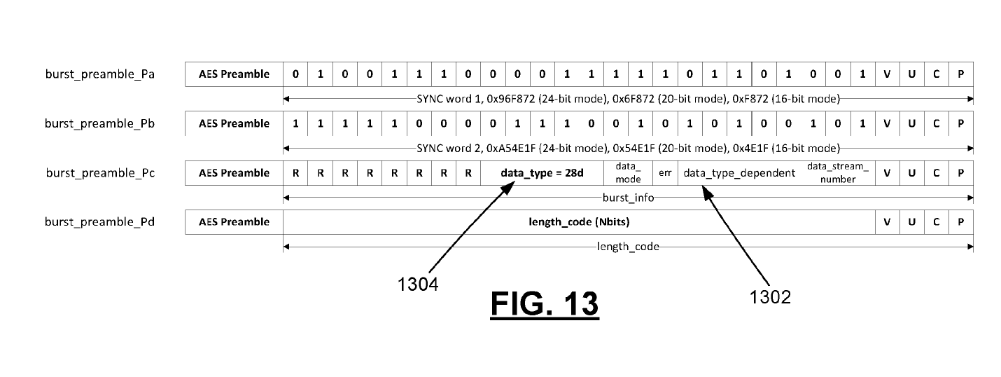

In some example embodiments, Dolby E Detection block 630 is provided to determine if the audio packets contain non-PCM data formatted as per Dolby E. Using Dolby E, up to eight channels of broadcast-quality audio, plus related metadata, can be distributed via any stereo (AES/EBU) pair. Dolby E is non-PCM encoded, but maps nicely into the AES3 serial audio format. Typically, any PCM audio processor must be disabled in the presence of Dolby E. In an example, Dolby E is embedded as per SMPTE 337M which defines the format for Non-PCM Audio and Data in an AES3 Serial Digital Audio Interface. Non-PCM packets contain a Burst Preamble (shown in FIG. 13). The burst_info word 1302 contains the 5-bit data_type identifier 1304, encoded as per SMPTE 338M. Dolby E is identified by data_type set to 28d. The HSI transmitter 204 decodes this information from the extracted ancillary data packet, and tags the corresponding Key Length Value (“KLV”) packet sequence as Dolby E. Tagging each packet as Dolby E allows audio monitoring equipment to very quickly determine whether it needs to enable or disable PCM processing.

Key Length Value (“KLV”) Formatting block 632 operates as follows. As audio/control/TFM data is read from the corresponding FIFO buffers 616, 618 and 620 (one byte per clock cycle) it is respectively encapsulated in a KLV packet 1112 (KLV audio data packet), 1704 (KLV audio control-HD packet), 1804 (KLV audio control-SD packet), 1904 (KLV TFM packet) (Where KLV=Key+Length+Value) as shown in FIGS. 11, 17, 18, and 19. In example embodiments, identification information such as a unique key 1110 is provided for each audio group, and a separate key 1710, 1810 is provided for its corresponding audio control packet 1704, 1804. In the illustrated example in FIG. 11, the KLV audio payload packet 1112 is 8 bits wide, and 255 unique keys can be used to distinguish ancillary data types. All audio payload data from a SMPTE audio data packet 1000, 1600 are mapped directly to the corresponding KLV audio payload packet 1112. Additional bits are used to tag each audio packet with attributes useful for downstream audio processing. Additional detail on KLV mapping is described below.

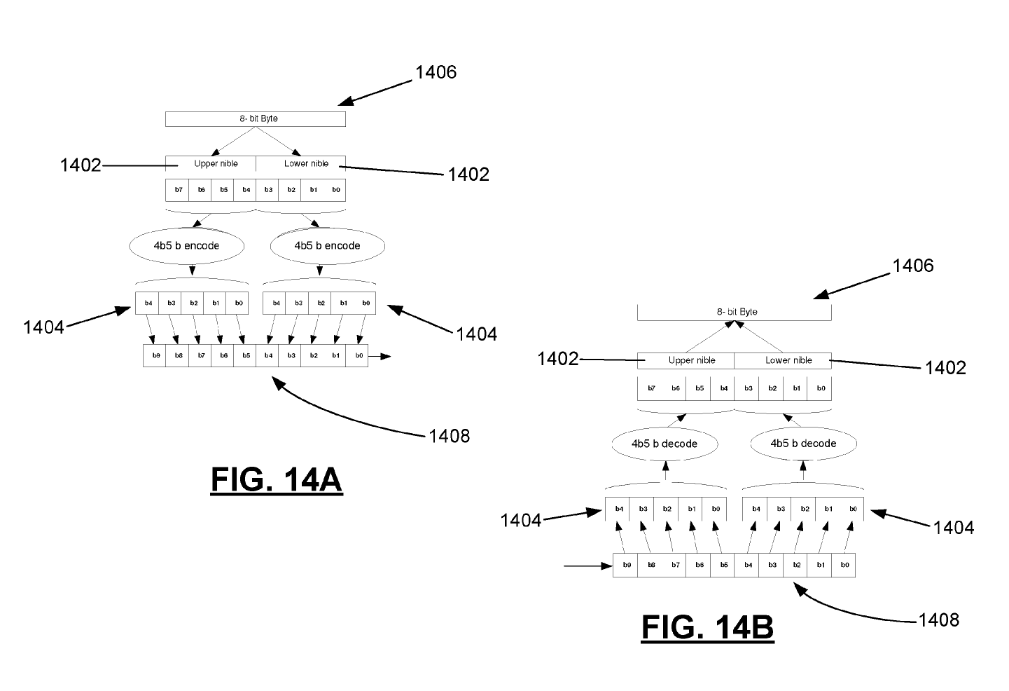

After KLV formatting, a number of encoding modules 660 perform further processing. The HSI data stream is 4b/5b encoded at 4b/5b encoding block 638 such that each 4-bit nibble 1402 is mapped to a unique 5-bit identifier 1404 (as shown in FIG. 14A, each 8-bit word 1406 becomes 10 bits 1408).

After 4b/5b encoding, packet Framing block 634 is used to add start-of-packet 1202 and end-of-packet 1204 delimiters to each KLV packet 1112, 1704, 1804, 1904 in the form of unique 8-bit sync words, prior to serialization (see FIGS. 12 and 20).

Sync Stuffing block 636 operates as follows. In one example of HSI transmitter 204, if less than eight groups of audio are extracted, then only these groups are transmitted on the HSI—the HSI stream is not padded with “null” packets for the remaining groups. Since each KLV packet 1112, 1704, 1804, 1904 contains a unique key 1110, 1710, 1810, 1910, the downstream logic only needs to decode audio groups as they are received. To maintain a constant data rate, the HSI stream is stuffed with sync (electrical idle) words 1206 that can be discarded by the receiving logic.

After sync stuffing, each 10-bit data word is non-return to zero inverted (“NRZI”) encoded by NRZI Encoding block 640 for DC balance, and serialized at Serialization block 642 for transmission. The combination of 4b5b encoding and NRZI encoding provides sufficient DC balance with enough transitions for reliable clock and data recovery.

Referring again to FIG. 8, HSI receiver 212 is embedded in SDI transmitter 211 which also includes an SDI transmitter circuit 800. In example embodiments, the HSI receiver 212 may insert up to 32 channels of digital audio into the horizontal blanking regions 102 of SD, HD & 3G SDI video streams. The HSI supplies ancillary data HSI-IN 850 as a serial data stream to the HSI receiver 212. In the HSI receiver 212 of FIG. 8, timing reference information embedded in each video line is extracted and used to control the ancillary data insertion process. As in the HSI transmitter 204, the HSI receiver 212 operates at a user-selectable clock rate HSI_CLK 852 to allow users to manage the overall latency of the audio processing path. The user-selectable clock rate HSI_CLK 852 may be a multiple of the video clock rate PCLK 854 to facilitate an easier FIFO architecture to transfer data to the video clock domain. However, the HSI receiver 212 can also run at a multiple of the audio sample rate.

The operation of the different functional blocks of the HSI receiver 212 will now be described according to one example embodiment. In one example, the HSI receiver 212, several decoding modules 860 process the incoming HSI data. HSI data (HSI-IN) 850 is deserialized by deserialization block 802 into a 10-bit wide parallel data bus. The parallel data is NRZI decoded by NRZI decoding block 804 so that the unique sync words that identify the start/end of KLV packets 1112, 1704, 1804 and audio sample clock edges 1210 can be detected in parallel.

The Packet Sync Detection block 808 performs a process wherein the incoming 10-bit data words are searched for sync words corresponding to the start-of-packet 1202 and end-of-packet 1204 delimiters. If a KLV packet 1112, 1704, 1804, 1904 is detected, the start/end delimiters 1202, 1204 are stripped to prepare the KLV packet 1112, 1704, 1804, 1904 for decoding.

After detecting the packet synchronization words, the HSI data is 4b/5b decoded by 4b/5b decoding block 806 such that each 5-bit identifier 1404 is mapped to a 4-bit nibble 1402 (each 10-bit word 1408 becomes 8-bits 1406, as shown in FIG. 14B).

After stripping the start/end delimiters 1202, 1204 from the parallel data stream and performing 4b/5b decoding, the KLV audio payload packets 1112 (or other KLV packets 1704, 1804, 1904) can be decoded by the KLV decode block 810 per the 8-bit Key value and assigned to a corresponding audio data FIFO buffer 812 (or control 814 or TFM 816 FIFO buffer). In particular, audio data 1114 is stripped from its KLV audio payload packet 1112 and stored in its corresponding group FIFO buffer 812. In an example, each audio group 904 is written to its designated FIFO buffer 812 in sample order so that samples received out-of-order are re-ordered prior to insertion into the SDI stream 900.

Audio control data is stripped from its KLV packet 1704, 1804 by KLV decode block 810 and stored in its corresponding group audio control data FIFO buffer 814. Each audio group control packet 1704, 1804 is written to separate respective audio control data FIFO buffers 814 for insertion on specified line numbers.

TFM data 1906 is also stripped from its KLV packet 1904 by KLV decode block 810 and stored in a TFM FIFO buffer 816 for insertion on a user-specified line number. The TFM FIFO buffer 816 is used to store the Two-Frame Marker packet 1902. This packet is transmitted once per frame, and is used to provide 2-frame granularity for downstream video switches. This prevents video switching events from “cutting across” ancillary data that is encoded based on a two-frame period (non-PCM audio data is in this category).

Collectively, the Audio Data FIFO buffer 812, Audio Control FIFO buffer 814, and TFM FIFO buffer 816 operate as buffering modules 856.

The data from the buffering modules 856 is then processed into the SDI stream by a number of serial data insertion modules 858.

A FIFO read controller 818 manages the clock domain transition from the HSI clock HSI_CLK 852 to the video pixel clock PCLK 854. Audio/control/TFM data written into its corresponding FIFO buffer 812/814/818 is read out, formatted as per SMPTE 291M, and inserted into the horizontal blanking area 102 of the SDI stream 900 by an ancillary data insertion block 836 that is part of the SDI transmitter circuit 800. The read controller 818 determines the correct insertion point for the ancillary data based on the timing reference signals present in the video stream PDATA, and the type of ancillary data being inserted.

A Reference Clock Sync Detection block 824 performs a process that searches the incoming 10-bit data words output from NRZI and 4b/5b decoding blocks 804,806 for sync words 1210 that correspond to the rising edge of the embedded sample clock reference 1212. The audio sample reference clock 1212 is re-generated by directly decoding these sync words 1210.

The recovered audio reference clock 1212 is used by audio cadence detection block 826 to count the number of audio samples per frame to determine the audio frame cadence. The audio frame cadence information 1116 is embedded into the audio control packets 1702, 1704 as channel status information at channel status formatting block 830.

A Dolby E detection block 828 detects KLV audio payload packets 1112 tagged as “Dolby E” (tagging is described in further detail below). This tag 1128 indicates the presence of non-PCM audio data which is embedded into SMPTE audio packets 1000, 1600 as channel status information at channel status formatting block 830.

The audio sample rate is extracted by audio sample rate detection block 842 from the KLV “SR” tag. Alternatively it can be derived by measuring the incoming period of the audio sample reference clock 1212.

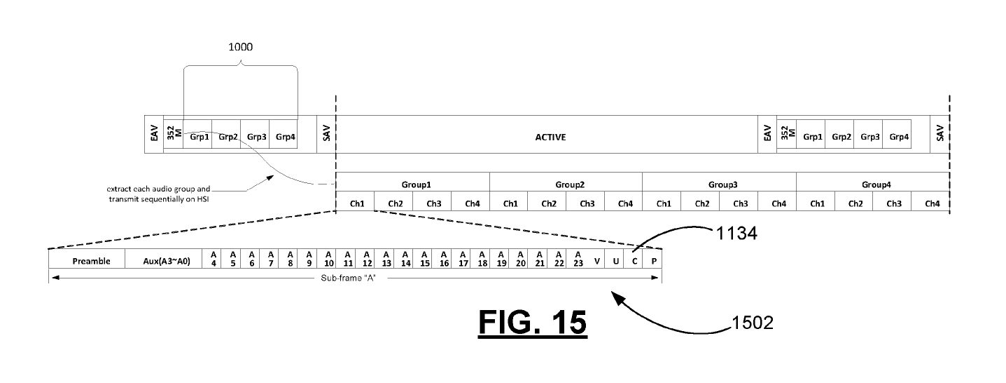

The channel status formatting block 830 extracts information embedded within KLV audio payload packets 1112 for insertion into SMPTE audio packets 1000, 1600 as channel status information. Channel status information is transmitted over a period of multiple audio packets using the “C” bit 1134 (2^{nd} most significant bit of the sub-frame 1502) as shown in FIG. 15. Channel status information includes the audio sample rate and PCM/non-PCM identification.

A clock sync generation block 822 generates clock phase words for embedding in the SMPTE audio packets 1000 for HD-SDI and 3G-SDI data, as per SMPTE 299M. Note that for SD-SDI video, clock phase words are not embedded into the audio data packets 1600.

All audio payload data and audio control data, plus channel status information and clock phase information 1132 is embedded within SMPTE audio packets 1000 that are formatted as per SMPTE 291M by SMPTE ancillary data formatter 820 prior to insertion in the SDI stream 900. Channel status information is encoded along with the audio payload data for that channel within the audio channel data segments of the SMPTE audio packet 1000, 1600.

The SDI transmitting circuit 800 of FIG. 8 includes a timing reference signal detection block 832, SDI processing block 834, ancillary data insertion block 836, scrambling block 838 and parallel to serial conversion block 840.

KLV mapping requirements will now be described in greater detail. In at least some applications, the HSI described herein may provide a serial interface with a simple formatting method that retains all audio information as per AES3, as shown in FIG. 15. In FIG. 15, each audio group comprises 4 channels.

In some but not all example applications, functional requirements of the HSI may include:
Support for synchronous and asynchronous audio.
Transmission of the following fundamental audio sample rates: 48 kHz and 96 kHz
Support for audio sample bit depths up to 24 bits
Transmission of audio control packets
Transmission of the audio frame cadence
Track the order in which audio samples from each audio group are received and transmitted

To address the functional requirements above, the audio sample data is formatted as per the KLV protocol (Key+Length+Value) as shown in FIG. 11. One unique key 1110 is provided for each audio group, and unique keys 1710, 1810 are also provided for corresponding audio control packets. All AES3 data from a given SMPTE audio data packet 1000 is mapped directly to the KLV audio payload packet 1112. In example embodiments, additional bits are used to tag each KLV audio payload packet 1112 with attributes useful for downstream audio processing:
GROUP ID 1110: one unique Key per audio group
LENGTH 1111: indicates the length of the value field, i.e. the audio data 1114
SAMPLE ID 1118: each audio group packet is assigned a rolling sample number from 0-7 to identify discontinuous samples after audio processing
CADENCE 1116: identifies the audio frame cadence (0 if unused)
DS 1120: dual stream identifier (see below)
SR 1122: fundamental audio sample rate; 0 for 48 kHz, 1 for 96 kHz
D 1124: sample depth; 0 for 20-bit, 1 for 24-bit
E 1126: ECC error indication
DE[1:0] 1128: Dolby E identifier
   DE[1]=Dolby E detected
   DE[0]=1 for active packet, 0 for null packet
R 1130: Reserved
C 1134: Channel status data

In example embodiments, the Z, V, U, C, and P bits as defined by the AES3 standard are passed through from the SMPTE audio data packet 1000 to the KLV audio payload packet 1112.

With reference to the DS bit 1120 noted above, if the incoming 3G-SDI stream is identified as dual-link by the video receiver, each 1.5 Gb/s link (Link A and Link B) may contain audio data. If the audio data packets in each link contain DIDs corresponding to audio groups 1 to 4 (audio channels 1 to 16) this indicates two unique 1.5 Gb/s links are being transmitted (2×HD-SDI, or dual stream) and the DS bit 1120 in the KLV audio payload packet 1112 is asserted. To distinguish the audio groups from each link, the HSI transmitter 204 maps the audio from Link B to audio groups 5 to 8. When the HSI receiver 212 receives this data with the DS bit 1120 set, this indicates the DIDs in Link B must be remapped back to audio groups 1 to 4 for ancillary data insertion. Conversely if the incoming 3G-SDI dual-link video contains DIDs corresponding to audio groups 1-4 on Link A, and audio groups 5-8 on Link B, the DS bit 1120 remains low, and the DIDs do not need to be re-mapped.

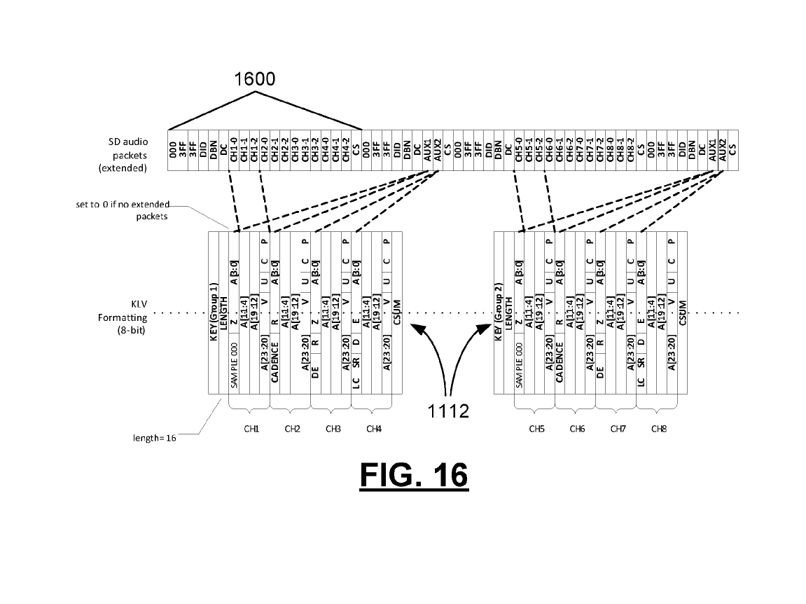

The KLV mapping approach shown in FIG. 11 is accurate for HD-SDI and 3G-SDI. At SD data rates, the audio packet defined in SMPTE 272M is structurally different from the HD and 3G packets, therefore the KLV mapping approach is modified. For SD audio packets, 24-bit audio is indicated by the presence of extended audio packets in the SDI stream 900 (as defined in SMPTE 272M). In this case, all 24-bits of the corresponding audio words are mapped into KLV audio payload packets 1112 as shown in FIG. 16. Note that SD audio packets 1600 do not contain audio clock phase words 1132, as the audio sample rate is assumed to be synchronous to the video frame rate.

As noted above, the audio sample reference clock 1212 is embedded into the HSI stream 1200 at the HSI transmitter 204. In some examples, the audio phase information may be derived in one of two ways: (a) For HD-SDI and 3G-SDI data, it is decoded from clock phase words 1132 in the SMPTE audio data packet; or (b) For SD-SDI, it is generated internally by the HSI transmitter 204 and synchronized to the video frame rate. The reference frequency will typically be 48 kHz or 96 kHz but is not limited to these sample rates. A unique sync pattern is used to identify leading edge of the reference clock 1212. As shown in FIG. 12 and FIG. 20 these clock sync words 1210 are interspersed throughout the serial stream, asynchronous to the audio packet 1112 bursts.

Decoding of these sync words 1210 at the HSI receiver 212 enables re-generation of the audio clock 1212, and halts the read/write of the KLV packet 1112 from its corresponding extraction/insertion FIFO.

In some example applications, the High-Speed Interface (HSI) described herein may allow a single-wire point-to-point connection (either single-ended or differential) for transferring multiple channels of digital audio data, which may ease routing congestion in broadcast applications where a large number of audio channels must be supported (including for example router/switcher designs, audio embedder/de-embedders and master controller boards). The single-ended or differential interface for transferring digital audio may provide a meaningful cost savings, both in terms of routing complexity and pin count for interfacing devices such as FPGAs. In some embodiments, the signal sent on the HSI is self-clocking. In some example configurations, the implementation of the 4b/5b+NRZI encoding/decoding for the serial link may be simple, efficient and provide robust DC balance and clock recovery. KLV packet formatting can, in some applications, provide an efficient method of presenting audio data, tagging important audio status information (including the presence of Dolby E data), plus tracking of frame cadences and sample ordering. In some examples, the use of the KLV protocol may allow for the transmission of different types of ancillary data and be easily extensible.

In some examples, the HSI operates at a multiple of the video or audio clock rate that is user-selectable so users can manage the overall audio processing latency. Furthermore, in some examples the KLV encapsulation of the ancillary data packet allows up to 255 unique keys to distinguish ancillary data types. This extensibility allows for the transmission of different types of ancillary data beyond digital audio, and future-proofs the implementation to allow more than 32 channels of digital audio to be transmitted.

Unique SYNC words 1210 may be used to embed the fundamental audio reference clock onto the HIS stream 1200. This provides a mechanism for recovering the fundamental sampling clock 1212, and allows support for synchronous and asynchronous audio.

In some example embodiments, tagging each packet as Dolby E data or PCM data allows audio monitoring equipment to quickly determine whether it needs to enable or disable PCM processing.

The integrated circuit chips 202, 210 can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product.

The present disclosure may be embodied in other specific forms without departing from its spirit or essential characteristics. The described embodiments are to be considered in all respects as being only illustrative and not restrictive. The present disclosure intends to cover and embrace all suitable changes in technology.

1. A method for retransmitting ancillary data received via a serial digital data input, comprising:
extracting ancillary data encoded in a serial digital data signal received over the serial digital data input;
assembling a plurality of data packets, each packet comprising:
identification information identifying the data packet;
length information identifying a length of the data packet; and
value information representing a portion of the extracted ancillary data;
sequentially encoding the plurality of data packets within a high-speed data stream; and
transmitting the high speed data stream via a high speed data output.

2. The method of claim 1, wherein the high speed data stream comprises a single self-clocking data stream sent single-ended or differentially.

3. The method of claim 1, wherein sequentially encoding further comprises encoding idle information within the high speed data stream during periods when no data packets are available for encoding within the high speed data stream.

4. The method of claim 1, wherein the ancillary data comprises at least one audio channel.

5. The method of claim 1, wherein the serial digital data signal is a HD video signal, a SD video signal, or a 3G SDI signal.

6. The method of claim 5, wherein the ancillary data is encoded within the horizontal blanking region of the video frames of the serial digital data signal.

7. The method of claim 4, wherein the data packets comprise:
audio data packets carrying audio payload data; and
audio control packets carrying audio control information.

8. The method of claim 7, wherein the data packets further comprise two-frame marker packets carrying two-frame granularity information.

9. The method of claim 7, wherein the data packets comprise packets containing sequence information about the sequential order of packets containing audio payload data.

10. The method of claim 4, wherein:
the ancillary data includes audio clock information; and
sequentially encoding further comprises encoding clock sync information within the high speed data stream at a period determined by the audio clock information.

11. The method of claim 4, wherein the at least one audio channel comprises a plurality of synchronous audio channels.

12. The method of claim 4, wherein the at least one audio channel comprises a plurality of asynchronous audio channels.

13. A device for retransmitting ancillary data from a received serial digital data signal, comprising:
a serial digital data input for receiving the serial digital data signal;
one or more serial data extraction modules for extracting and storing ancillary data encoded in the serial digital data signal;
one or more data formatting modules for assembling a plurality of data packets, each packet comprising:
identification information identifying the data packet;
length information identifying a length of the data packet; and
value information representing a portion of the stored ancillary data;
one or more encoding modules for sequentially encoding the plurality of data packets within a high-speed data stream; and
a high speed data output for transmitting the high speed data stream.

14. The device of claim 13, wherein the high speed data output comprises a single-ended or differential electrical link.

15. The device of claim 13, wherein the one or more encoding modules encode idle information within the high speed data stream during periods when no data packets are available for encoding within the high speed data stream.

16. The device of claim 13, wherein the ancillary data comprises at least one audio channel.

17. The device of claim 13, wherein the serial digital data input is a HD video input, a SD video input, or a 3G SDI input.

18. The device of claim 17, wherein the ancillary data is encoded within the horizontal blanking region of the video frames of the serial digital data signal.

19. The device of claim 16, wherein the data packets comprise:
audio data packets carrying audio payload data; and
audio control packets carrying audio control information.

20. The device of claim 19, wherein the data packets further comprise two-frame marker packets carrying two-frame granularity information.

21. The device of claim 19, wherein the data packets comprise packets containing sequence information about the sequential order of packets containing audio payload data.

22. The device of claim 16, wherein:
the ancillary data includes audio clock information; and
the one or more encoding modules encode clock sync information within the high speed data stream at a period determined by the audio clock information.

23. The device of claim 16, wherein the at least one audio channel comprises a plurality of synchronous audio channels.

24. The device of claim 16, wherein the at least one audio channel comprises a plurality of asynchronous audio channels.

25. The device of claim 13, wherein the one or more encoding modules comprise:
a bit width encoding module for encoding the data packets to the bit width of the high speed data stream; and
a serializer module for serializing the bit-width-encoded data packets to create the high speed data stream.

26. A method for retransmitting data received over a high speed data input, comprising:
receiving a high speed data stream via the high speed data input;
receiving a digital data signal via a serial data input;
decoding a sequence of data packets from the high speed data stream, each packet comprising:
identification information identifying the data packet;
length information identifying a length of the data packet; and
value information;
extracting the value information from the data packets;
encoding the value information into the digital data signal as ancillary data;
transmitting the digital data signal with the encoded ancillary data as a serial digital data signal via a serial data output.

27. The method of claim 26, wherein the high speed data stream comprises a single self-clocking data stream sent single-ended or differentially.

28. The method of claim 26, wherein decoding further comprises identifying a sync word marking the beginning of a data packet in the high speed data stream.

29. The method of claim 26, wherein the ancillary data comprises at least one audio channel.

30. The method of claim 26, wherein the serial digital data signal is a HD video signal, a SD video signal, or a 3G SDI signal.

31. The method of claim 30, wherein the ancillary data is encoded within the horizontal blanking region of the video frames of the serial digital data signal.

32. The method of claim 29, wherein the data packets comprise:
audio data packets carrying audio payload data; and
audio control packets carrying audio control information.

33. The method of claim 32, wherein the data packets further comprise two-frame marker packets carrying two-frame granularity information.

34. The method of claim 32, wherein the data packets comprise packets containing sequence information indicating the sequential order of packets containing audio payload data, the method further comprising storing the audio payload data from the data packets in the order indicated by the sequence information.

35. The method of claim 29, wherein:
the ancillary data includes audio clock information; and
decoding further comprises decoding clock sync information within the high speed data stream.

36. The method of claim 29, wherein the at least one audio channel comprises a plurality of synchronous audio channels.

37. The method of claim 29, wherein the at least one audio channel comprises a plurality of asynchronous audio channels.

38. A device for retransmitting high speed data, comprising:
a high speed data input for receiving a high speed data stream;
a serial data input for receiving a serial digital data signal;
one or more decoding modules for decoding a sequence of data packets from the high speed data stream, each packet comprising:
identification information identifying the data packet;
length information identifying a length of the data packet; and
value information;
one or more serial data insertion modules for encoding the value information into the serial digital data signal as ancillary data;
a serial data output for transmitting the serial digital data signal with the encoded ancillary data.

39. The device of claim 38, wherein the high speed data output comprises a single-ended or differential electrical link.

40. The device of claim 38, wherein the one or more decoding modules identity a sync word marking the beginning of a data packet in the high speed data stream.

41. The device of claim 38, wherein the ancillary data comprises at least one audio channel.

42. The device of claim 38, wherein the digital data input is a HD video input, a SD video input, or a 3G SDI input and the serial data output is a HD video input, a SD video input, or a 3G SDI input.

43. The device of claim 42, wherein the ancillary data is encoded within the horizontal blanking region of the video frames of the serial digital data signal.

44. The device of claim 41, wherein the data packets comprise:
audio data packets carrying audio payload data; and
audio control packets carrying audio control information.

45. The device of claim 44, wherein the data packets further comprise two-frame marker packets carrying two-frame granularity information.

46. The device of claim 44, wherein the data packets comprise packets containing sequence information indicating the sequential order of packets containing audio payload data, the device further comprising one or more buffer modules for storing the audio payload data from the data packets in the order indicated by the sequence information.

47. The device of claim 41, wherein the at least one audio channel comprises a plurality of synchronous audio channels.

48. The device of claim 41, wherein the at least one audio channel comprises a plurality of asynchronous audio channels.

49. The device of claim 38, wherein the one or more decoding modules comprise:
a deserializer module for deserializing the high speed data stream; and
a bit width decoding module for decoding the data packets from the bit width of the high speed data stream into the bit width used by the serial data insertion modules.

50. A method of transmitting a plurality of channels of audio data, comprising:
assembling a plurality of data packets, each packet comprising:
identification information identifying the data packet;
length information identifying a length of the data packet; and
value information representing data from one or more of the plurality of audio channels;
framing each data packet with information indicating the start and end of the packet;
encoding each data packet sequentially into a high speed data stream;
transmitting the high speed data stream.

51. The method of claim 50, wherein:
the plurality of channels of audio data includes audio sample clock information; and
encoding further comprises inserting audio sample clock sync words into the high speed data stream at intervals determined by the audio sample clock information.

52. The method of claim 50, wherein encoding further comprises inserting idle sync words into the high speed data stream at times when no audio data from the plurality of channels of audio data is available for insertion.

53. The method of claim 50, wherein the high speed data stream is self-clocking.

54. The method of claim 50, wherein transmitting comprises transmitting the high speed data stream via a single-ended or differential output.
